(19) United States
(12) Patent Application Publication
(10) Pub. No.: US 2026/0187283 A1
(43) Pub. Date: Jul. 2, 2026

(54) METHOD AND APPARATUS WITH VIRTUAL DATA GENERATION

(71) Applicant: SAMSUNG ELECTRONICS CO., LTD., Suwon-si (KR)

(72) Inventors: Soobeom JANG, Suwon-si (KR); Junsoo Ha, Suwon-si (KR)

(73) Assignee: SAMSUNG ELECTRONICS CO., LTD., Suwon-si (KR)

(21) Appl. No.: 19/412,354

(22) Filed: Dec. 8, 2025

(30) Foreign Application Priority Data
Jan. 2, 2025 (KR) 10-2025-0000435

(51) Int. Cl. G06F 21/62

(52) U.S. Cl. CPC G06F 21/6254

(57) ABSTRACT

A processor-implemented method including extracting a statistical characteristic and a distribution characteristic from original data including an independent variable and a dependent variable representing a process phenomenon, generating a characteristic of virtual data based on the statistical characteristic, generating a parameter adjustment method according to the characteristic of the virtual data, generating a virtual data generation method according to the distribution characteristic, generating sample data for the virtual data generation method for performing an evaluation process to obtain an evaluation process result for the sample data, redefining a standard production parameter or generating the virtual data based on the result of the process, and anonymizing the virtual data based on an anonymization operation.

### CROSS-REFERENCE TO RELATED APPLICATION

This application claims priority to and the benefit of Korean Patent Application No. 10-2025-0000435 filed with the Korean Intellectual Property Office on January 2, 2025, the entire contents of which are incorporated herein by reference.

### BACKGROUND

### (a) Field

The present disclosure relates to a method and apparatus with virtual data generation.

### (b) Description of the Related Art

Data generation techniques may have two main goals. The first is to hide sensitive information that may occur during the data learning process, and the second is to increase the learning performance of a machine learning model. However, considering the purpose of solving an optimization problem that proposes optimal independent variables based on a relationship between independent and dependent variables in manufacturing and development environments, the goal of such data generation techniques may not be suitable due to the following points.

Typical techniques aimed at hiding sensitive information often mainly consider only the distributional similarity between independent variables, and may not sufficiently reflect the relationship between independent and dependent variables. In particular, since most or all of the data from the data generation (e.g., process phenomenon data) may correspond to sensitive information, it may be difficult to apply a method of replacing some of the data. That is, there is a desire to conceal process-specific characteristics of manufacturing data to provide data that reflects the observed manufacturing environment while concealing process specific data considered to be confidential (i.e., process phenomena).

Meanwhile, typical data generation techniques for improving learning performance do not sufficiently consider the reliability of dependent variables and have the problem of not guaranteeing performance outside the range of existing dependent variable values. In addition, solving optimization problems in manufacturing environments requires the inclusion of data that may exceed the range of dependent variable values while requiring that the reliability of the dependent variable in that domain is maintained. However the typical method do not support these requirements.

### SUMMARY

In a general aspect, here is provided a processor-implemented method including extracting a statistical characteristic and a distribution characteristic from original data including an independent variable and a dependent variable representing a process phenomenon, generating a characteristic of virtual data based on the statistical characteristic, generating a parameter adjustment method according to the characteristic of the virtual data, generating a virtual data generation method according to the distribution characteristic, generating sample data for the virtual data generation method for performing an evaluation process to obtain an evaluation process result for the sample data, redefining a standard production parameter or generating the virtual data based on the result of the process, and anonymizing the virtual data based on an anonymization operation.

The anonymizing may include replacing a value of a categorical variable with a randomly generated string.

The anonymizing may include one of linearly transforming a value of a continuous variable and transforming a value of a continuous variable using an inverse function.

The statistical characteristic may include one or more of a variable type, a probability distribution, a maximum value, a minimum values, a mean, a variance, and a trends in an independent variable change between samples and the distribution characteristic may include one or more of a generation period of data, a ratio of an evaluation sample to a production sample, and an evaluation ratio of each sample.

The parameter adjustment method may include one or more of a parameter adjustment strategy, a parameter modification range, and modeling of a process phenomenon.

The virtual data generation method may include modeling a virtual process phenomenon and the virtual data generation method may be defined by one or more of a ratio of production samples to evaluation samples, an evaluation ratio, a standard production parameter change strategy, and a temporal change.

The modeling the virtual process phenomenon may include simulating the process phenomenon according to one of a polynomial function and a function including an arbitrary coefficient.

The standard production parameter change strategy may include redefining the standard production parameter based on a virtual process result from the modeling of the virtual process phenomenon for the standard production parameter and an evaluation parameter applied in the modeling of the virtual process phenomenon.

The parameter adjustment strategy may include one or more of random adjustment, genetic algorithm, Bayesian optimization, and reinforcement learning.

The modeling of the process phenomenon may be performed using one or more of linear interpolation, a neural network, a support vector machine, and a random forest.

In a general aspect, here is provided an electronic apparatus including one or more processors including processing circuitry and a memory including one or more storage media storing instructions that, when executed individually or collectively by the one or more processors, cause the electronic apparatus to extract a statistical characteristic and a distribution characteristic from original data including an independent variable and a dependent variable representing a process phenomenon, generate a characteristic of virtual data according to the statistical characteristic,

generate a parameter adjustment method according to the characteristic of the virtual data, generate a virtual data generation method according to the distribution characteristic, generate sample data for the virtual data generation method for performing an evaluation process to obtain an evaluation process result, redefine a standard production parameter or generate the virtual data based on the result of the process, and anonymize the virtual based on an anonymization operation data.

The anonymizing may include replacing a value of a categorical variable with a randomly generated string.

The anonymizing may include one of linearly transforming a value of a continuous variable and transforming a value of a continuous variable using an inverse function.

The statistical characteristic may include one or more of a variable type, a probability distribution, a maximum value, a minimum values, a mean, a variance, and a trends in an independent variable change between samples and the distribution characteristic may include at least some of a generation period of data, a ratio of an evaluation sample to a production sample, and an evaluation ratio of each sample.

The parameter adjustment method may include one or more of a parameter adjustment strategy, a parameter modification range, and modeling of a process phenomenon.

The instructions may further cause the electronic apparatus to model a virtual process phenomenon and the virtual data generation method is defined by one or more of a ratio of production samples to evaluation samples, an evaluation ratio, a standard production parameter change strategy, and a temporal change.

The modeling the virtual process phenomenon may include simulating the process phenomenon according to one of a polynomial function a function including an arbitrary coefficient.

The standard production parameter change strategy may include redefining the standard production parameter based on a virtual process result from the modelling of the virtual process phenomenon for the standard production parameter and an evaluation parameter applied in the modeling of the virtual process phenomenon.

The parameter adjustment strategy may include one or more of random adjustment, genetic algorithm, Bayesian optimization, and reinforcement learning.

The modeling of the process phenomenon may be performed using one or more of linear interpolation, a neural network, a support vector machine, and a random forest.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an example apparatus virtual data generation according to one or more embodiments.

FIG. 2 to FIG. 5 illustrate example operations of an apparatus with virtual data generation according to one or more embodiments.

FIG. 6 illustrates an example method with virtual data generation according to one or more embodiments.

FIG. 7 illustrates an example electrical device according to one or more embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term "may" herein with respect to an example or embodiment (e.g., as to what an example or embodiment may include or implement) means that at least one example or embodiment exists where such a feature is included or implemented, while all examples are not limited thereto. The use of the terms "example", "embodiment", and "example embodiment" herein have a same meaning (e.g., the phrasing 'in an or one example' has a same meaning as 'in an or one embodiment" and 'in an or one example embodiment'), and "one or more examples" has a same meaning as "one or more embodiments" and "one or more example embodiments". Still further, each of multiple or all separately described an/one "example", "embodiment", "example embodiment", as well as "examples", "embodiments", "example embodiments", herein may be included, in combination, in a same embodiment in any combination.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

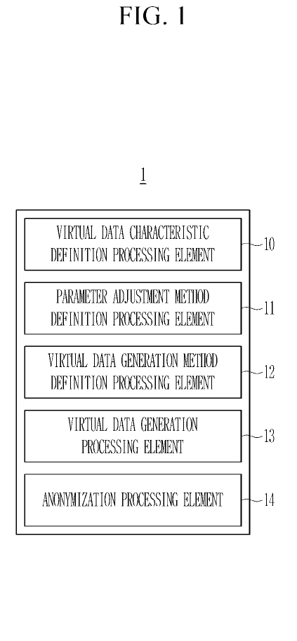

FIG. 1 illustrates an example apparatus virtual data generation according to one or more embodiments.

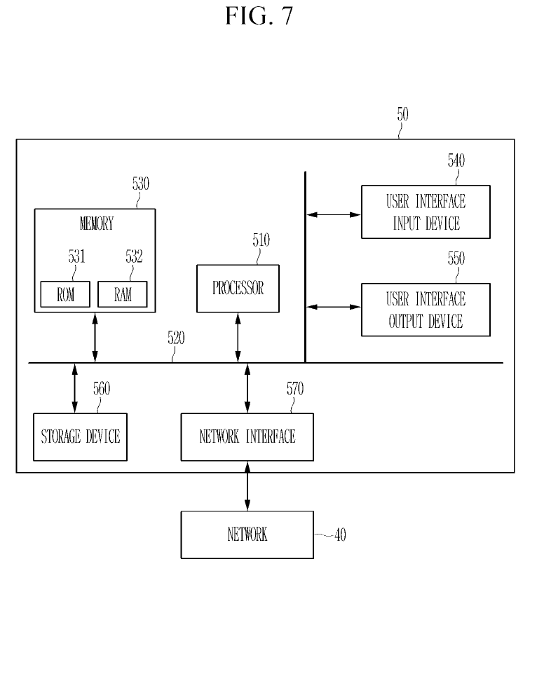

Referring to FIG. 1, in a non-limiting example, an apparatus 1 for generating virtual data may execute a program code or instruction stored in one or more memory devices through one or more processors. For example, the apparatus 1 for generating virtual data may be implemented as a computing device 50 as described later with reference to FIG. 7. In this case, one or more processors may correspond to a processor 510 of the computing device 50, and one or more memory devices may correspond to a memory 520 of the computing device 50. The program code or instruction may be executed by one or more processors to generate virtual data.

The apparatus 1 for generating virtual data may include a virtual data characteristic definition processing element 10, a parameter adjustment method definition processing element 11, a virtual data generation method definition processing element 12, a virtual data generation processing element 13, and an anonymization processing element 14.

In an example, the virtual data characteristic definition processing element 10 may extract statistical characteristics and distribution characteristics from original data. Here, the original data may be sensitive production data including a process phenomenon. The original data may include an independent variable and a dependent variable representing a process phenomenon (i.e., data containing confidential aspects of the manufacturing process of which there is a desire to conceal from virtual data obtained from the original data). That is, some data may be confidential, such as data related to the manufacture of particular semiconductors while other factors concerning the characteristics of the manufacturing environment may not be considered confidential. The independent variable is directly controlled during the process step and may directly affect product quality and productivity. For example, temperature or pressure in the etching process may affect the uniformity of fine patterns as an independent variable, and the gas mixing ratio in the deposition process can affect the thickness and uniformity of the thin film, and these variables may be understood as independent variables. The dependent variable may represent a process result that varies according to a set value of the independent variable. The dependent variable can be used as a criterion for evaluating the final performance of the process and may correspond to the optimization goal of the manufacturing environment. For example, the lower the defect rate of the wafer, the more successfully the process may be evaluated, and the more the deviation in the film thickness is minimized, the higher the precision of the process may be evaluated.

In an example, the statistical characteristics may include at least some of the variable types, such as probability distributions, maximum values, minimum values, means, variances, and trends in independent variable changes between samples. For example, the variable type of the statistical characteristic may represent the data type of the variable such as categorical, continuous, and sequential types, and accordingly, the variable processing method may be determined in the data analysis and modeling process. For example, the probability distribution may represent how data is distributed around a specific value and may take various forms, such as a normal distribution, binomial distribution, or Poisson distribution. For example, the maximum and minimum values may define the range of data, while the mean represents the central tendency of the data and may be used to summarize the trends of the entire data. For example, the variance is a measure of how spread out the data are from the mean, and may be used to analyze the variability of the data. For example, the trends may occur in independent variable changes between samples represent patterns in which data change over time or other conditions, and may provide information for analyzing interactions between variables or identifying trends in a process environment.

In an example, the virtual data characteristic definition processing element 10 may define characteristics of virtual data based on the extracted statistical characteristics. The characteristics of the virtual data may be used to generate data that may hide or change the process phenomenon. The characteristics of the virtual data may be defined by selectively using some of the extracted statistical characteristics. In this case, the characteristics of the original data may be directly reflected, and the statistical characteristic values may be arbitrarily changed and utilized according to specific requirements or data protection purposes. For example, virtual data can be generated by maintaining main statistical characteristics of the original data, such as the mean and variance, while adjusting the correlations between variables or distribution characteristics. The virtual data generated through this may have characteristics similar to those of actual data, while minimizing the risk of exposure of sensitive information (e.g., process phenomena) that may arise from the original data.

In an example, the parameter adjustment method definition processing element 11 may define a parameter adjustment method based on the characteristics of virtual data. The parameter adjustment method may include one or more of a parameter adjustment strategy, a parameter correction range, and modeling of a process phenomenon. For example, the parameter adjustment strategy may include at least one of random adjustment, a genetic algorithm, Bayesian optimization, and reinforcement learning. In addition, the modeling of the process phenomenon may be performed using at least one of linear interpolation, a neural network, a support vector machine, and a random forest.

For example, the parameter adjustment method definition processing element 11 may be designed to efficiently change process data or search for optimal parameters through a defined parameter adjustment method. For example, the random adjustment may change parameters using random values, and the genetic algorithm may operate by gradually improving parameters based on evolutionary principles. In another example, the Bayesian optimization may efficiently reduce the search space using probabilistic models, and the reinforcement learning may learn optimal adjustment methods by utilizing reward feedback for parameter changes to achieve a specific goal. Meanwhile, the modeling of the process phenomenon may be used as a method for simulating the characteristics of the actual process in a virtual environment. The linear interpolation may represent processes based on simple functions, while the neural network may learn complex nonlinear relationships to provide advanced process models. The support vector machine may define the boundary conditions of the process through data classification or regression analysis, and the random forest may analyze the process data utilizing a plurality of decision trees.

In an example, the virtual data generation method definition processing element 12 may define a virtual data generation method based on distribution characteristics. For example, the distribution characteristic may include at least one of a generation period of data, a ratio of an evaluation sample to a production sample, and an evaluation ratio of each sample. Specifically, the distribution characteristic is designed to reflect the temporal and structural characteristics of the data generation environment. For example, the generation cycle of data may determine the frequency at which production samples and evaluation samples are generated based on specific time intervals. A ratio of evaluation samples to production samples represents a proportion of evaluation data within the entire dataset, and this ratio may be used to adjust the amount of evaluation data required to analyze and optimize process data. For example, evaluation data may be generated using parameters within the process that have been partially modified from standard parameters through evaluations of the process. In addition, the evaluation ratio of each sample defines the proportion of data among the generated data samples that undergo the actual evaluation process, which may be used as a criterion for monitoring and analyzing the performance of the process.

In an example, the virtual data generation method may include a virtual process phenomenon, and may include at least one of a ratio of production samples to evaluation samples, an evaluation ratio, a standard production parameter change strategy, and a temporal change. The ratio of production samples to evaluation samples may control the balance between evaluation data and production data during the data generation process, enabling appropriate data configuration for analysis and optimization. For example, the evaluation ratio represents the proportion of data among the generated evaluation samples that actually undergo the evaluation process, and the standard production parameter change strategy may define a method to identify parameters during the evaluation process that are important and/or considered to be optimal for a particular evaluated process and to adopt them as new standard production parameters. For example, the temporal change may reflect dynamic changes in the composition ratio of production samples and evaluation samples or the generation cycle during the data generation process, and may include variability that may occur in an actual manufacturing environment.

In some examples, the virtual process phenomenon may be modeled through simulations of the process phenomenon, modeled as a polynomial function or a neural network, or modeled as a function including arbitrary coefficients.

In some examples, the standard production parameter change strategy may include changing the standard production parameters based on the virtual process results for the standard production parameters and the evaluation parameters.

In an example, the virtual data generation processing element 13 can define sample data according to a virtual data generation method and perform a process to obtain a process result. In addition, the virtual data generation processing element 13 may redefine standard production parameters or generate virtual data based on the results of the process.

The virtual data generation processing element 13 may analyze the results of the generated evaluation samples to identify evaluation parameters that show levels of performance that exceed preset standards for the manufacturing process (i.e., parameters that provide above average results), for example, and adopt those identified parameters as new standard production parameters. In this process, the performance of the evaluation parameter may be determined according to a performance index or process goal of the dependent variable, and parameters that meet specific criteria, such as quality indicators, productivity indicators, etc., may be selected. In an example, a parameter redefinition process may be performed iteratively, and process data may be gradually improved through a cycle of generating production samples and evaluation samples using new standard production parameters and then re-evaluating them. In addition, the virtual data generation processing element 13 may support flexible adjustment of standard production parameters by considering various factors of the process environment, such as temporal changes or changes in external conditions.

In an example, the anonymization processing element 14 may hide information of virtual data through anonymization. In some examples, the anonymization may be performed by replacing values of categorical variables with randomly generated strings. In other examples, the anonymization may be performed by distribution distortion by linearly transforming the values of continuous variables or by transforming them using inverse functions. That is, the anonymization processing element 14 may apply a predetermined anonymization operation to the virtual data in order to hide some information about the process phenomenon or parameters included in the original data (for example, the name of the gas, the physical characteristics of the etching process, and the like in the case of a semiconductor process) from being revealed. For example, the anonymization operation may include at least one of an operation for replacing values of a categorical variable with a randomly generated string, an operation for linearly transforming values of a continuous variable, and an operation for transforming values of a continuous variable using an inverse function.

Specifically, the anonymization processing element 14 may apply various anonymization techniques to protect sensitive information in virtual data, and may hide or change sensitive characteristics of original data while maintaining the validity of the data. In an example, the anonymization may be performed by adjusting or removing correlations between specific variables to minimize their association with the original data. In addition, the distribution distortions generated during the anonymization process may be designed so that sensitive information is not exposed while maintaining statistical characteristics necessary for data analysis and modeling. For example, the identifiability of the original data may be reduced by transforming the values of the variables into nonlinear functions or reconstructing their probabilistic distributions. Accordingly, the security of virtual data may be strengthened while increasing data usability. In some embodiments, the anonymization processing element 14 may be selectively applied in the initial, intermediate, or final steps of the data generation process, and may adjust the level of anonymization according to specific application needs.

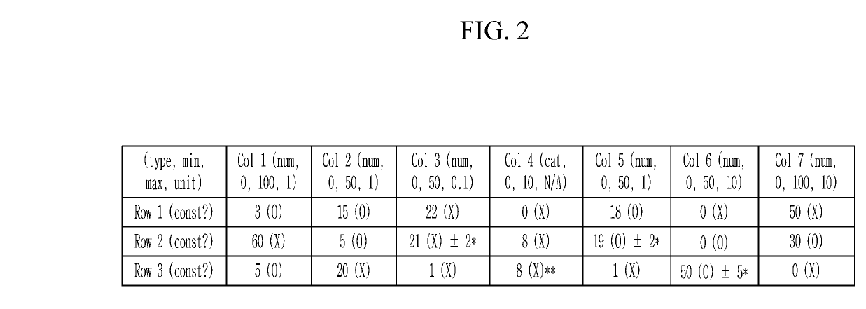

FIG. 2 to FIG. 5 illustrate example operations of an apparatus with virtual data generation according to one or more embodiments.

Referring to FIG. 2, an example of standard production parameters with described distribution characteristics and statistical characteristics is illustrated. In this way, the form in which data may be transformed in each portion of the sample data may be defined using statistical characteristics and distribution characteristics extracted from the original data.

Referring to the second column in FIG. 2, "Col1 (num, 0, 100, 1)" indicates that the value of Col1 is a numeric variable with a minimum value of 0, a maximum value of 100, and a variation range of 1. Therefore, Col1 may have values of 0, 1, 2, 3, ..., 99, and 100. For example, the Col1 value of Row1 is indicated by 3(O), which indicates that the current standard value may be 3 and may be changed. On the other hand, the Col1 value of Row2 is indicated by 60(X), indicating that the corresponding value is immutable.

In the example illustrated in the fifth column of FIG. 2, "Col4 (cat, 0, 10, N/A)" indicates that the value of Col4 is a categorical variable, with a minimum value of 0 and a maximum value of 10. Thus, Col4 may have values of 0, 1, 2, ..., 9, and 10, but this is considered a categorical value rather than a numerical value. The Col4 value of Row3 is expressed as 8(X)**, where ** means that the Col4 value of Row3 must always be the same as that of Row2. That is, when the value of Row2 is changed, the value of Row3 is also changed equally.

The Col6 value of Row3 is expressed as 50(O)±5, where ±5 means that any variation may be applied to the parameter value within the range of ±5. This variation reflects the case where the equipment autonomously determines and corrects parameters in an actual process or where unexpected noise is introduced.

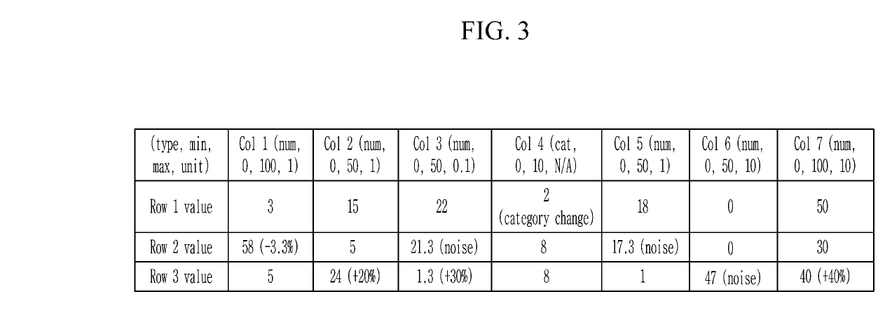

Referring to FIG. 3, an example of parameters in which some of the standard production parameters are modified is illustrated.

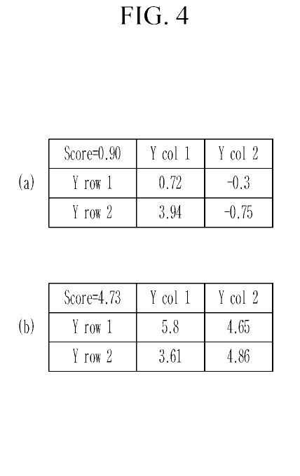

Referring to FIG. 4, in a non-limiting example, (a) illustrates an evaluation result obtained by applying a virtual process to the data of FIG. 2, and (b) illustrates an evaluation result obtained by applying a virtual process to the data of FIG. 3. The evaluation result may be configured of a plurality of values, and a function summarizing a plurality of evaluation values into one or more evaluation values may be applied for conversion of standard parameters. In an example, the average value of all evaluation values is used as a summary function, and the corresponding average value is indicated as a score in the upper left corner of the table. When the score of the evaluation value obtained by applying the process to the data of FIG. 3 is higher, the standard process may be changed to the data of FIG. 3. As the evaluation process is repeated, the contents of the summary function used may change.

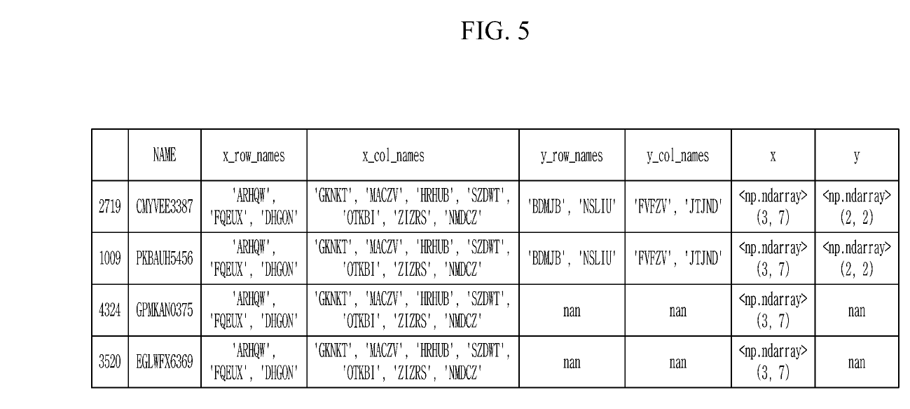

Referring to FIG. 5, an example of generated virtual data is illustrated including virtual data generated by repeating the processes of FIG. 2, FIG. 3,

and FIG. 4 multiple times. For example, the values of the "y_row_names", "y_col_names", and "y" columns of data numbers 4324 and 3520 are marked as “nan”, which means that evaluation is not performed on some of the production samples. For example, the values of "x_row_names", "x_col_names", "y_row_names", and "y_col_names" are all the same, and the sizes of the x and y arrays are written to be the same. However, there is a possibility that these values and array sizes may vary depending on specific conditions.

In an example, the virtual data that is generated through the apparatus 1 for generating virtual data may have the following characteristics. Most of the data may correspond to standard production parameters and may have a constant x value. The x values are partly numeric and partly categorical, may vary according to set rules, and may sometimes be noisy. The y value may not be evaluated in some cases, and when it is evaluated, various types of values may occur. The y value is processed by the summary function, and depending on the result of the summary function, whether or not the standard parameter is switched may be determined. When an x value that generates a better y value is found (e.g., parameters that show levels of performance that exceed preset standards for the manufacturing process), that value may be adopted as a new standard production parameter, and, accordingly, the standard production parameter may change over time. In addition, the actual process phenomenon is not indicated, and thus the sensitive information may be protected by further anonymization using virtual strings.

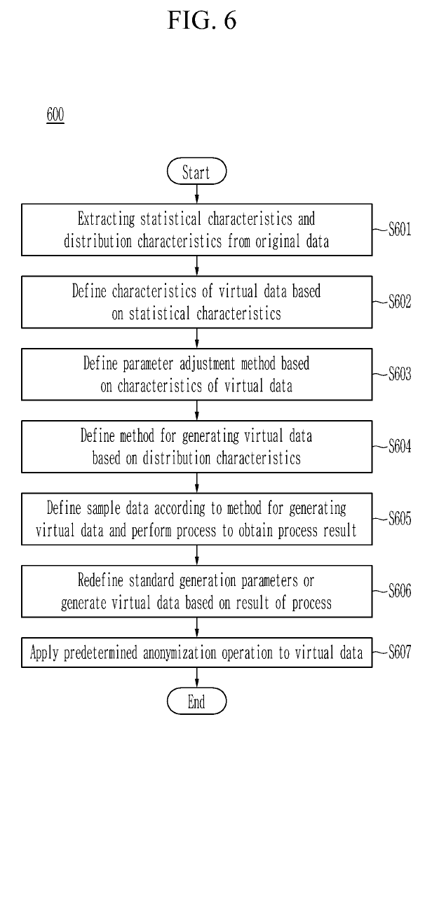

FIG. 6 illustrates an example method with virtual data generation according to one or more embodiments.

Referring to FIG. 6, in a non-limiting example, an electronic apparatus (e.g., electronic apparatus 50 of FIG. 7) may perform virtual data generation through a method 600 with virtual data generation which may include extracting statistical characteristics and distribution characteristics from original data in step S601, defining characteristics of virtual data based on the statistical characteristics in step S602, defining a parameter adjustment method based on the characteristics of virtual data in step S603, define a method for generating virtual data based on the distribution characteristics in step S604, defining sample data according to the method for generating virtual data and performing a process to obtain a process result in step S605, redefining a standard generation parameters or generating virtual data based on the result of the process in step S606, and applying a predetermined anonymization operation to virtual data in stepS607.

For more detailed descriptions on the virtual data generation method according to the embodiment, reference may be made to the descriptions of the embodiments described herein, so redundant descriptions thereof will be omitted.

FIG. 7 illustrates an example electrical device according to one or more embodiments.

Referring to FIG. 7, in a non-limiting example, a method (e.g., method 600) and an apparatus (e.g., for generating virtual data according to embodiments may be implemented using an electronic device 50. The electronic device 50 may be implemented as various types of electronic devices, servers, or similar devices, and its function may be implemented through a combination of software and hardware.

The electronic device 50 may include at least one of a processor 510, a memory 530, a user interface input device 540, a user interface output device 550, and a storage device 560 in communication through a bus 520. The electronic device 50 may also include a network interface 570 electrically connected to the network 40. The network interface 570 may transmit or receive signals with other entities through the network 40.

The processor 510 may be configured to execute programs or applications to configure the processor 510 to control the electronic device 50 to perform one or more or all operations and/or methods involving the generation of virtual data. The processor 510 may be implemented as various types of computing devices, such as a micro controller unit (MCU), an application processor (AP), a central processing unit (CPU), a graphic processing unit (GPU), a natural processing unit (NPU), and a quantum processing unit (QPU). The processor 510 is a semiconductor device that executes instructions stored in the memory 530 or the storage device 560, and may play a key role in the system. Program codes and data stored in the memory 530 or the storage device 560 instruct the processor 510 to perform a specific task, thereby enabling the overall operation of the system. The processor 510 may be configured to implement various functions and methods described above with respect to FIG. 1 to FIG. 6.

The memory 530 may include computer-readable instructions. The processor 510 may be configured to execute computer-readable instructions, such as those stored in the memory 530, and through execution of the computer-readable instructions, the processor 510 may be configured to perform one or more, or any combination, of the operations and/or methods described herein. The memory 530 and the storage device 560 may include various types of volatile or non-volatile storage media for storing and accessing data of the system. For example, the memory 530 may include a read-only memory (ROM) 531 and a random access memory (RAM) 532. In some embodiments, the memory 530 may be embedded in the processor 510, and in this case, the data transmission speed between the memory 530 and the processor 510 may be very fast. In some other embodiments, the memory 530 may be disposed outside the processor 510, in which case the memory 530 may be connected to the processor 510 through various data buses or interfaces. This connection can be made through a variety of known members, such as a peripheral component interconnect express (PCIe) interface for high-speed data transmission or through a memory controller.

In an example, at least some of the components or functions of the method and apparatus for generating virtual data according to the embodiments may be implemented as a program or software executed on the electronic device 50, and the program or software may be stored in a computer-readable recording medium or storage medium. Specifically, in an example, the computer-readable recording medium or storage medium according to the embodiment may be one writing the program for executing the steps included in the implementation of the method and apparatus for generating virtual data according to the embodiments to a computer including the processor 510 that executes the program or instruction stored in the memory 530 or the storage device 560.

In some examples, at least some of the components or functions of the method and apparatus for generating virtual data according to the embodiments may be implemented using hardware or circuits of the electronic device 50, or may be implemented using separate hardware or circuits that may be electrically connected to the electronic device 50.

In an example, it may be possible to generate virtual data that may be used for learning purposes while protecting sensitive process data occurring in a manufacturing environment. Specifically, by implementing the relationship between production data and evaluation data, parameter variation targets, and evaluation cycles in a virtual simulation in a manufacturing environment, the statistical characteristics of the data may be maintained while hiding or changing the process characteristics. This provides valid data that may be used for learning and model development without exposing actual process data to the outside. In particular, it is possible to generate data including the specificity of the productivity and quality improvement process by reflecting parameter variations in the manufacturing environment and the change characteristics of production samples. As a result, it is possible to develop statistical models that reflect the unique characteristics of the manufacturing environment while protecting sensitive data, and it is possible to contribute to supporting reliable data analysis and machine learning applications while hiding process phenomena.

The electronic devices, neural networks, memories, processors, apparatus 1 for generating virtual data, virtual data characteristic definition processing element 10, parameter adjustment method definition processing element 11, virtual data generation method definition processing element 12, virtual data generation processing element 13, anonymization processing element 14, electronic device 50, processor 510, a memory 530, user interface input device 540, user interface output device 550, storage device 560, and network interface 570 described herein, including descriptions with respect to respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term "processor" or "computer" may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-7 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
extracting a statistical characteristic and a distribution characteristic from original data including an independent variable and a dependent variable representing a process phenomenon;
generating a characteristic of virtual data based on the statistical characteristic;
generating a parameter adjustment method according to the characteristic of the virtual data;
generating a virtual data generation method according to the distribution characteristic;
generating sample data for the virtual data generation method for performing an evaluation process to obtain an evaluation process result for the sample data;
redefining a standard production parameter or generating the virtual data based on the result of the process; and
anonymizing the virtual data based on an anonymization operation.

2. The method for generating virtual data of claim 1, wherein the anonymizing comprises:
replacing a value of a categorical variable with a randomly generated string.

3. The method for generating virtual data of claim 1, wherein the anonymizing comprises one of:
linearly transforming a value of a continuous variable; and
transforming a value of a continuous variable using an inverse function.

4. The method for generating virtual data of claim 1, wherein the statistical characteristic includes one or more of a variable type, a probability distribution, a maximum value, a minimum values, a mean, a variance, and a trends in an independent variable change between samples, and
wherein the distribution characteristic includes one or more of a generation period of data, a ratio of an evaluation sample to a production sample, and an evaluation ratio of each sample.

5. The method for generating virtual data of claim 1, wherein the parameter adjustment method includes one or more of a parameter adjustment strategy, a parameter modification range, and modeling of a process phenomenon.

6. The method for generating virtual data of claim 1, wherein the virtual data generation method comprises:
modeling a virtual process phenomenon, and
wherein the virtual data generation method is defined by one or more of a ratio of production samples to evaluation samples, an evaluation ratio, a standard production parameter change strategy, and a temporal change.

7. The method for generating virtual data of claim 6, wherein the modeling the virtual process phenomenon comprises:
simulating the process phenomenon according to one of a polynomial function and a function including an arbitrary coefficient.

8. The method for generating virtual data of claim 6, wherein the standard production parameter change strategy comprises:
redefining the standard production parameter based on a virtual process result from the modeling of the virtual process phenomenon for the standard production parameter and an evaluation parameter applied in the modeling of the virtual process phenomenon.

9. The method for generating virtual data of claim 5, wherein the parameter adjustment strategy includes one or more of random adjustment, genetic algorithm, Bayesian optimization, and reinforcement learning.

10. The method for generating virtual data of claim 5, wherein the modeling of the process phenomenon is performed using one or more of linear interpolation, a neural network, a support vector machine, and a random forest.

11. An electronic apparatus, comprising:
one or more processors comprising processing circuitry; and
a memory comprising one or more storage media storing instructions that, when executed individually or collectively by the one or more processors, cause the electronic apparatus to:
extract a statistical characteristic and a distribution characteristic from original data including an independent variable and a dependent variable representing a process phenomenon,
generate a characteristic of virtual data according to the statistical characteristic,
generate a parameter adjustment method according to the characteristic of the virtual data,
generate a virtual data generation method according to the distribution characteristic,
generate sample data for the virtual data generation method for performing an evaluation process to obtain an evaluation process result,
redefine a standard production parameter or generate the virtual data based on the result of the process, and
anonymize the virtual based on an anonymization operation data.

12. The electronic apparatus for generating virtual data of claim 11, wherein anonymizing comprises:
replacing a value of a categorical variable with a randomly generated string.

13. The electronic apparatus for generating virtual data of claim 11, wherein anonymizing comprises one of:
linearly transforming a value of a continuous variable; and
transforming a value of a continuous variable using an inverse function.

14. The electronic apparatus for generating virtual data of claim 11, wherein the statistical characteristic includes one or more of a variable type, a probability distribution, a maximum value, a minimum values, a mean, a variance, and a trends in an independent variable change between samples, and
wherein the distribution characteristic includes at least some of a generation period of data, a ratio of an evaluation sample to a production sample, and an evaluation ratio of each sample.

15. The electronic apparatus for generating virtual data of claim 11, wherein the parameter adjustment method includes one or more of a parameter adjustment strategy, a parameter modification range, and modeling of a process phenomenon.

16. The electronic apparatus for generating virtual data of claim 11, wherein the instructions further cause the electronic apparatus to:
model a virtual process phenomenon, and
wherein the virtual data generation method is defined by one or more of a ratio of production samples to evaluation samples, an evaluation ratio, a standard production parameter change strategy, and a temporal change.

17. The electronic apparatus for generating virtual data of claim 16, wherein the modeling the virtual process phenomenon comprises:
simulating the process phenomenon according to one of a polynomial function a function including an arbitrary coefficient.

18. The electronic apparatus for generating virtual data of claim 16, wherein the standard production parameter change strategy comprises:
redefining the standard production parameter based on a virtual process result from the modelling of the virtual process phenomenon for the standard production parameter and an evaluation parameter applied in the modeling of the virtual process phenomenon.

19. The electronic apparatus for generating virtual data of claim 15, wherein the parameter adjustment strategy includes one or more of random adjustment, genetic algorithm, Bayesian optimization, and reinforcement learning.

20. The electronic apparatus for generating virtual data of claim 15, wherein the modeling of the process phenomenon is performed using one or more of linear interpolation, a neural network, a support vector machine, and a random forest.
